(19) United States
(12) Patent Application Publication
(10) Pub. No.: US 2013/0323074 A1
(43) Pub. Date: Dec. 5, 2013

(54) FRICTION WELDED TURBINE DISK AND SHAFT

(71) Applicants: John E. Matz, San Diego, CA (US); Timothy M. Hollman, San Diego, CA (US); Xinwen Xiao, San Diego, CA (US); Phillip Creed, San Diego, CA (US)

(72) Inventors: John E. Matz, San Diego, CA (US); Timothy M. Hollman, San Diego, CA (US); Xinwen Xiao, San Diego, CA (US); Phillip Creed, San Diego, CA (US)

(73) Assignee: Hamilton Sundstrand Corporation, Windsor Locks, CT (US)

(21) Appl. No.: 13/485,676

(22) Filed: May 31, 2012

(51) Int. Cl. F01D 5/02; B23P 17/00

(52) U.S. Cl. 416/241 R; 29/889.2

(57) ABSTRACT

An assembly for use in a turbine of a gas turbine engine includes a turbine disk and a shaft. The turbine disk comprises a superalloy. The shaft is friction welded to the turbine disk at a shaft interface substantially adjacent the turbine disk.

### BACKGROUND

The present invention relates to gas turbine engines, and in particular, to turbine disks for use in turbine sections of gas turbine engines.

Gas turbine engines include various sections and components which can be subjected to very high temperatures. For example, a turbine section of a gas turbine engine is positioned downstream of a combustor section. Consequently, certain components in the turbine section can experience some of the highest temperatures in a gas turbine engine. However, not all components are subjected to the same temperatures. Similarly, certain components can be subjected to high loads, but not all components need to withstand the same loads.

Gas turbine engines are typically designed with systems designed to cool certain components. It can also be desirable to design components using materials capable of withstanding high temperatures. However, certain high temperature materials can be undesirably expensive. Moreover, such materials can be challenging to use in certain manufacturing operations.

### SUMMARY

According to the present invention, an assembly for use in a turbine of a gas turbine engine includes a turbine disk and a shaft. The turbine disk comprises a superalloy. The shaft is friction welded to the turbine disk at a shaft interface substantially adjacent the turbine disk.

Another embodiment of the present invention includes a method of fabricating a turbine disk assembly. The method includes creating a forging of superalloy material having a diameter at least twice its thickness, machining a turbine disk from the forging, and friction welding a shaft to the turbine disk at a shaft interface substantially adjacent a hub of the turbine disk.

### BRIEF DESCRIPTION OF THE DRAWINGS

FIG. 1 is a partial side sectional view of a gas turbine engine.

FIG. 2 is a partial side sectional exploded view of a turbine disk, a spacer shaft, and an aft shaft for use in the gas turbine engine of FIG. 1.

FIG. 3 is a side sectional view of a forging for use in manufacturing the turbine disk of FIG. 2.

### DETAILED DESCRIPTION

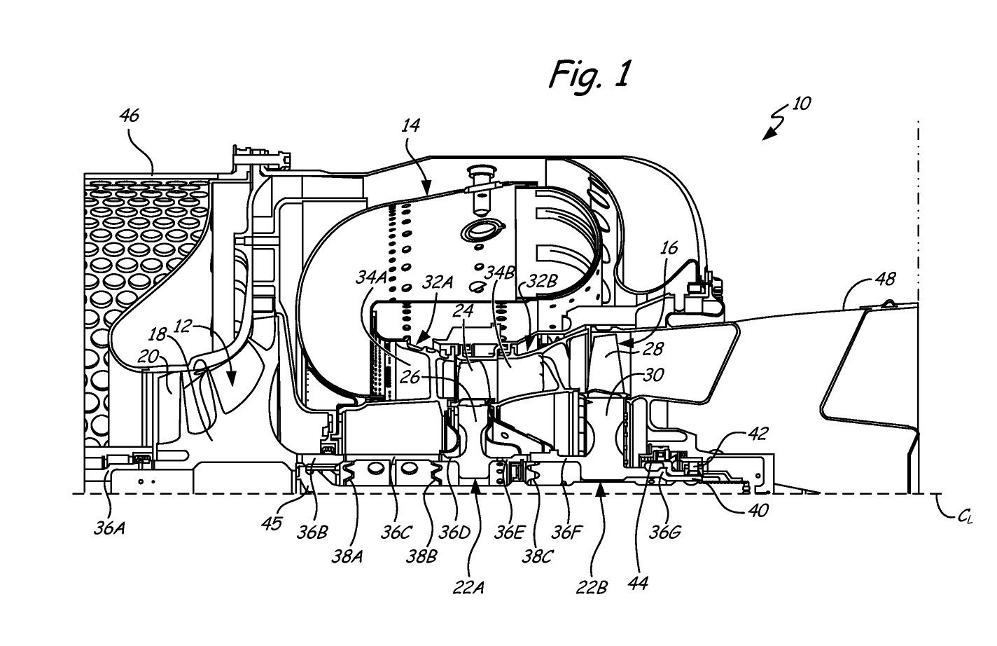

FIG. 1 is a partial side sectional view of gas turbine engine 10. In the illustrated embodiment, gas turbine engine 10 is an auxiliary power unit including compressor 12, combustor 14, and turbine 16. Compressor 12 includes compressor rotor 18 (which includes compressor blades 20). Turbine 16 includes first stage turbine rotor 22A (which includes turbine blades 24 connected to turbine disk 26), second stage turbine rotor 22B (which includes turbine blades 28 connected to turbine disk 30), first stage turbine stator 32A (which includes stator vanes 34A), and second stage turbine stator 32B (which includes stator vanes 34B). In the illustrated embodiment, compressor 12 is an impeller having a one-piece construction with compressor blades 20 being integral with compressor rotor 18. In the illustrated embodiment, turbine blades 24 are part of a first stage and turbine blades 28 are part of a second stage, downstream of the first stage.

A series of shafts 36A-36G connect and support compressor 12 and turbine 16. Shaft 36C is connected to shafts 36B and 36D via curvic couplings 38A and 38B, respectively. Shafts 36E and 36F are spacer shafts connected via curvic coupling 38C. In the illustrated embodiment, no other curvic coupling exists between turbine disk 26 and turbine disk 30. Shafts 36E and 36F connect and provide spacing between turbine disk 26 and turbine disk 30. Shaft 36G is an aft shaft having bearing interface section 40 which supports bearing 42. Seal 44, which limits air flow between opposite sides of seal 44, is also positioned on shaft 36G. Tie-bolt 45 is positioned radially inward of shafts 36A-36G and is put in tension so as to hold compressor 12 to turbine 16.

In operation, air flows from inlet 46 to compressor 12, where it is compressed and passed to combustor 14. Compressed air in combustor 14 is mixed with fuel to form a blended gas which is combusted and passed to turbine 16. As the combusted gas is forced over turbine blades 24 and 28 of turbine 16, turbine 16 and compressor 12 are forced to rotate about centerline axis C_{L}. The gas then flows from turbine 16 to outlet 48.

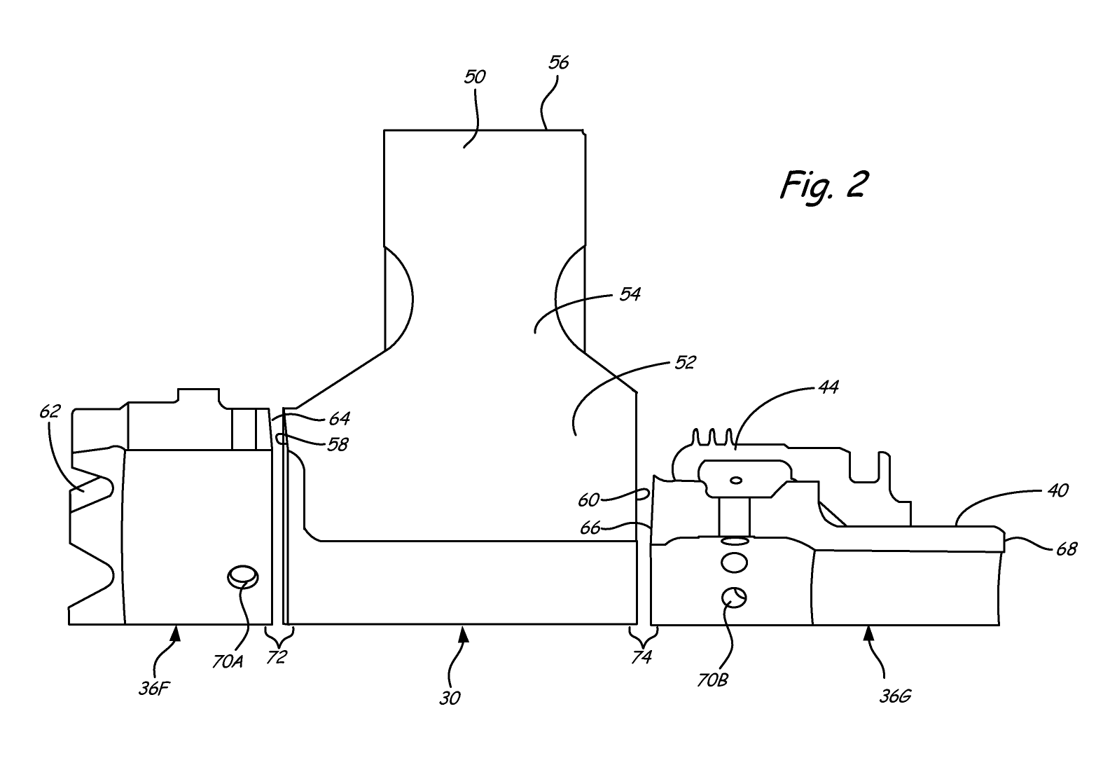

FIG. 2 is a partial side sectional exploded view of turbine disk 30, spacer shaft 36F, and aft shaft 36G. Turbine disk 30 includes rim 50, hub 52, and web 54 connecting rim 50 to hub 52. Rim 50 is radially outward of hub 52. Web 54 is relatively thin as compared to rim 50 and hub 52. Blade interface 56 is positioned at an outer diameter of rim 50 to provide a surface for attaching turbine blades 28 (shown in FIG. 1). Turbine disk 30 has front shaft interface 58 to provide a surface for attaching to spacer shaft 36F and has aft shaft interface 60 to provide a surface for attaching to aft shaft 36G. Shaft interfaces 58 and 60 are substantially adjacent hub 52.

Spacer shaft 36F is a substantially annular shaft that has curvic coupling interface 62 for connecting spacer shaft 36F to spacer shaft 36E (shown in FIG. 1) and has disk interface 64 to provide a surface for attaching to turbine disk 30. Aft shaft 36G is a substantially annular shaft that has disk interface 66 to provide a surface for attaching to turbine disk 30 and has aft terminal end 68. Cooling air holes 70A and 70B extend through spacer shaft 36F and aft shaft 36G, respectively, to provide secondary air flow used to cool and pressurize turbine 16 (shown in FIG. 1). In the illustrated embodiment, spacer shaft 36F and aft shaft 36G are annular, hollow shafts. In alternative embodiments, spacer shaft 36F and/or aft shaft 36G can be solid, non-hollow shafts.

Spacer shaft 36F is friction welded to turbine disk 30. In one method of friction welding, inertia welding (also known as spin welding), can be used to connect spacer shaft 36F to turbine disk 30. Either spacer shaft 36F or turbine disk 30 is held in place while the other is rotated. Then spacer shaft 36F and turbine disk 30 are moved closer together such that front shaft interface 58 and disk interface 64 come into contact, which creates friction that causes heat generation at the point of contact and effectively welds spacer shaft 36F to turbine disk 30. This creates friction weld joint 72, which provides a relatively strong and economical connection between spacer shaft 36F and turbine disk 30. Aft shaft 36G can be friction welded to turbine disk 30 in a similar manner to create friction weld joint 74. In alternative embodiments, friction weld joints 72 and 74 can be created via another friction welding technique, such as linear friction welding.

In the illustrated embodiment, aft shaft 36G is connected to turbine disk 30 and is free of curvic couplings. No curvic coupling is positioned between bearing interface section 40 and hub 52. No curvic coupling is positioned between bearing interface section 40 and seal 44. Also in the illustrated embodiment, spacer shaft 36F is free of curvic couplings internally (that is, spacer shaft 36F does not have any curvic couplings between disk interface 64 and curvic coupling interface 62); but spacer shaft 36F does, of course, have curvic coupling interface 62 at an upstream end which is part of curvic coupling 38C (shown in FIG. 1).

In the illustrated embodiment, disk interface 64 and front shaft interface 58 are both angled with respect to a radial direction, which is a direction that extends radially outward from centerline axis C_{L} (shown in FIG. 1). In the illustrated embodiment, disk interface 64 and front shaft interface 58 are angled by about 10° from the radial direction so as to have frusto-conical shapes. The angled frusto-conical shape of disk interface 64 is complimentary to the angled frusto-conical shape of front shaft interface 58 so as to accommodate substantially flat, abutting contact during friction welding. In alternative embodiments, disk interface 64 and/or front shaft interface 58 can be angled by about 3° to about 10° from the radial direction. In further alternative embodiments, one or both of disk interface 64 and front shaft interface 58 can be aligned substantially parallel to the radial direction.

Similarly, in the illustrated embodiment, disk interface 66 is also angled with respect to the radial direction. Aft shaft interface 60 is aligned substantially parallel to the radial direction. Consequently, in the illustrated embodiment, disk interface 66 and aft shaft interface 60 are not shaped to have flat, abutting contact with one-another. During friction welding, however, disk interface 66 and/or aft shaft interface 60 can plasticize and then harden together so as to have a substantially uniform and solid friction weld. In an alternative embodiment, disk interface 66 and/or aft shaft interface 60 can be angled by about 3° to about 10° from the radial direction. In further alternative embodiments, the angled frusto-conical shape of disk interface 66 can be complimentary to the angled frusto-conical shape of aft shaft interface 60, similar to those of disk interface 64 and front shaft interface 58. In further alternative embodiments, disk interface 64, front shaft interface 58, disk interface 66, and aft shaft interface 60 can have different angles and alternative shapes, so long as those angles and shapes are suitable for friction welding in the particular application.

Turbine disk 30 can be made of a superalloy known as DA-718 (also known as direct age 718). Spacer shaft 36F and aft shaft 36G can be made of a superalloy known as Inconel-718. DA-718 and Inconel-718 are chemically similar nickel and chromium based superalloys. Inconel-718 is subjected to a process that includes first receiving thermo-mechanical work, next receiving a first heat treatment, and then receiving a second heat treatment. Unlike Inconnel-718, DA-718 does not receive the first heat treatment as a separate step. Instead, DA-718 is subjected to a process that includes first receiving thermo-mechanical work and then receiving the second heat treatment. For DA-718, the first heat treatment is, effectively, performed simultaneously with the step or receiving thermo-mechanical work. This differing process allows DA-718 to achieve improved material properties, including improved creep and fatigue properties. Use of friction welding allows for turbine disk 30 to be made of DA-718 and be integrally connected to shafts 36F and 36G made of Inconel-718. In alternative embodiments, turbine disk 30, spacer shaft 36F, and aft shaft 36G can be made of other superalloys suitable for a particular application, such as other nickel based superalloys or cobalt based super alloys. Turbine disk 30 can be made of a superalloy different from that of spacer shaft 36F and/or aft shaft 36G. For example, turbine disk 30 can be made of Waspaloy 718+ or Powder IN-100. Spacer shaft 36F and/or aft shaft 36G can be made of Steel 15-5 PH. In a further alternative embodiment, turbine disk 30, spacer shaft 36F, and aft shaft 36G can be made of a common superalloy.

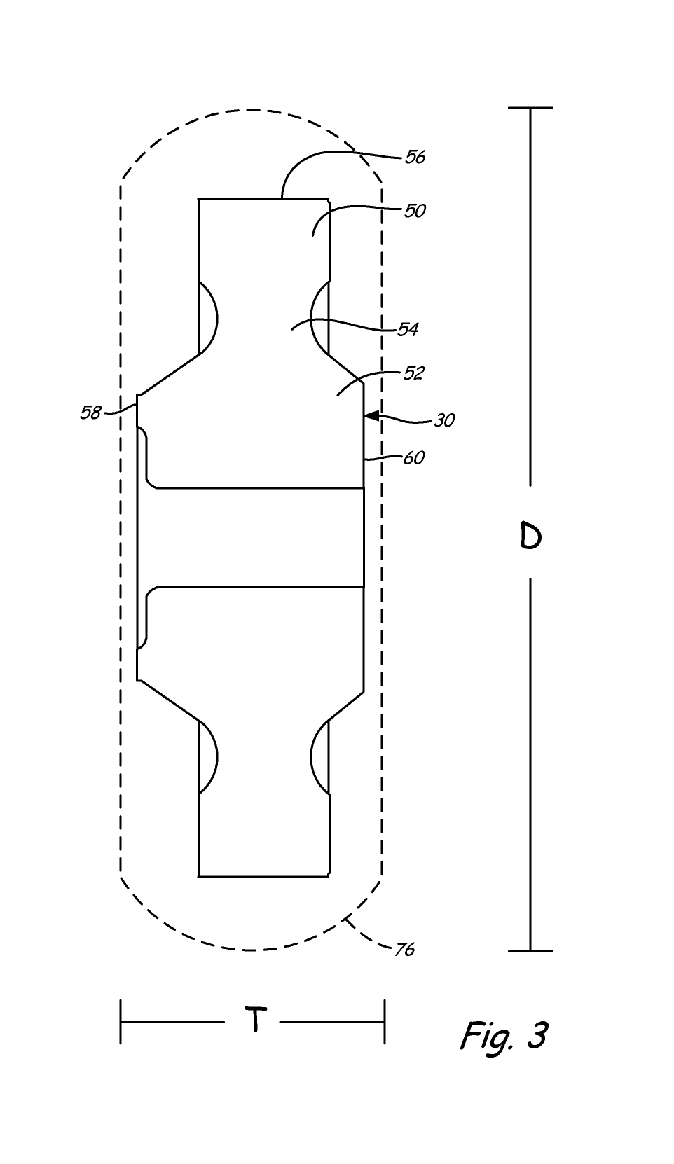

FIG. 3 is a side sectional view of forging 76, which can be used in manufacturing turbine disk 30. In the illustrated embodiment, forging 76 is substantially pancake-shaped, having thickness T that is relatively thin as compared to its diameter D. For example, forging 76 can have diameter D which is at least twice its thickness T. The shape and proportions of forging 76 allow for forging 76 to be made of superalloy material DA-718 with improved material properties. Turbine disk 30 can then be machined to shape from forging 76, and have the improved material properties. Turbine disk 30 can also be friction welded to one or both of spacer shaft 36F and aft shaft 36G (shown in FIG. 2). In one manufacturing method, forging 76 can first be manufactured in its illustrated pancake-shape. Forging 76 can then be partially machined (also called “pre-machined”) to prepare forging 76 for friction welding to one or both of spacer shaft 36F and aft shaft 36G. Front shaft interface 58 and/or aft shaft interface 60 can be machined as desired, such as being machined to an angle between 3° and 10° from the radial direction. During the pre-machining step, forging 76 may not yet have the final shape of turbine disk 30. After pre-machining forging 76, it can then be friction welded to one or both of spacer shaft 36F and aft shaft 36G in a manner described above. Forging 76 can then be machined further so as to have the final shape of turbine disk 30, as illustrated. One or both of spacer shaft 36F and aft shaft 36G can also be machined as necessary at the same time, for example to machine friction weld joints 72 and/or 74 to shape.

Turbine disk 26 (shown in FIG. 1) can be made in a similar manner as described above with respect to turbine disk 30. Turbine disk 26 can be connected to shaft 36D and/or shaft 36E (shown in FIG. 1) in a manner similar to that described above with respect to turbine disk 30 being connected to shafts 36F and 36G.

In some of the above-described embodiments, friction welding shafts 36F and/or 36G to turbine disk 30 can have certain benefits. Friction welding can allow shafts 36F and 36G to be connected to turbine disk 30 without use of curvic couplings that can be expensive and time-consuming. Friction welding can allow shafts 36F and 36G to be made of a different superalloy than that of turbine disk 30, thus allowing turbine disk 30 to be made of a relatively expensive superalloy without requiring shafts 36F and 36G to be made of the same superalloy. This can be beneficial in applications where turbine disk 30 needs to withstand higher temperature and/or strength requirements than the requirements needed of shafts 36F and 36G. Friction welding can further allow shafts 36F and 36G to be integrally connected to turbine disk 30, without requiring shafts 36F and 36G to be part of the same forging as that of turbine disk 30. This can allow turbine disk 30 to be made of a forging having a shape (such as a pancake shape) conducive to achieving improved material properties using DA-718 superalloy material. This is in contrast to having to use another shape (such as a spherical shape) that would allow shafts 36F and 36G to be part of the forging, but that may be less conducive to creating a suitable forging of DA-718 superalloy material. Further, by using a forging sized and shaped for a turbine disk without one or more attached shafts, a common forging can be used for turbine disks used in different engines, even if those disks attach to shafts having different sizes.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. For example, gas turbine engine 10 need not be constructed exactly as illustrated, but could instead be another type of gas turbine engine.

1. An assembly for use in a turbine of a gas turbine engine, the assembly comprising:
a turbine disk comprising a superalloy;
a spacer shaft friction welded to the turbine disk at a front shaft interface substantially adjacent the turbine disk; and
an aft shaft friction welded to an aft shaft interface substantially adjacent the turbine disk.

2. The assembly of claim 1, wherein the turbine disk is formed of DA-718, wherein the spacer shaft is formed of Inconel-718, and wherein the aft shaft is formed of Inconel-718.

3. The assembly of claim 1, wherein the turbine disk is formed of a first superalloy and wherein the spacer shaft and the aft shaft are formed of a second superalloy.

4. The assembly of claim 1, and further comprising:
a second turbine disk comprising a superalloy connected to the spacer shaft.

5. The assembly of claim 4, and further comprising:
a curvic coupling connecting the second turbine disk to the spacer shaft, wherein no other curvic coupling exists between the turbine disk and the second turbine disk.

6. The assembly of claim 1, wherein the aft shaft is free of curvic couplings.

7. An assembly for use in a turbine of a gas turbine engine, the assembly comprising:
a turbine disk comprising a superalloy and further comprising:
a rim;
a hub; and
a web connecting the rim to the hub;
a shaft friction welded to the turbine disk at a shaft interface substantially adjacent the hub of the turbine disk.

8. The assembly of claim 7, wherein the shaft comprises a spacer shaft.

9. The assembly of claim 8, and further comprising:
a second turbine disk having a second hub connected to the turbine disk via the spacer shaft.

10. The assembly of claim 7, wherein the shaft comprises an aft shaft and wherein the shaft interface is an aft shaft interface.

11. The assembly of claim 10, wherein the aft shaft comprises a bearing interface section and wherein no curvic coupling is positioned between the bearing interface section and the hub.

12. The assembly of claim 7, wherein the shaft interface is angled by between 3° and 10° from a radial direction.

13. The assembly of claim 7, wherein the turbine disk is formed of DA-718 and wherein the shaft is formed of Inconel-718.

14. The assembly of claim 7, wherein the turbine disk is formed of a first superalloy and wherein the shaft is formed of a second superalloy.

15. The assembly of claim 7, and further comprising:
a plurality of turbine blades connected to the rim.

16. A method of fabricating a turbine disk assembly, the method comprising:
creating a forging of superalloy material;
partially machining the forging to partially form a turbine disk;
friction welding a shaft to the turbine disk at a shaft interface substantially adjacent a hub of the turbine disk; and
further machining the turbine disk to shape the turbine disk.

17. The method of claim 16, wherein the forging is substantially pancake-shaped.

18. The method of claim 16, wherein the superalloy material is formed of DA-718, and wherein the shaft is formed of a second superalloy material different than DA-718.

19. The method of claim 16, wherein the shaft comprises a spacer shaft, wherein the shaft interface comprises a front shaft interface, and further comprising:
friction welding an aft shaft to the turbine disk at an aft shaft interface substantially adjacent the hub.

20. The method of claim 16, and further comprising:
machining the shaft interface to an angle between 3° and 10° from a radial direction.
